(19) United States
(12) Patent Application Publication
(10) Pub. No.: US 2012/0096024 A1
(43) Pub. Date: Apr. 19, 2012

(54) ASSISTANCE METHOD FOR A CALL CENTER OPERATOR

(76) Inventors: Christian Jacolot, Brest (FR); Sophie Bogard, Brest (FR)

(21) Appl. No.: 13/256,411

(22) PCT Filed: Feb. 12, 2010
(86) PCT No.: PCT/FR2010/050243

§ 371 Date: Dec. 28, 2011

(30) Foreign Application Priority Data
Mar. 16, 2009 (FR) 095651

(51) Int. Cl. G06F 17/30; G06F 15/16

(52) U.S. Cl. 707/769; 707/E17.014

(57) ABSTRACT

The present invention pertains to method for assisting an operator from a call center who must respond to a request for information (200), received by that call center, by means of a standard response stored in a base (306, 310) of standard responses, this base (306, 310) of standard responses being automatically used in order to provide the operator (302) with possible responses to the request for information (200), characterized in that it comprises the following steps:
the step of identifying elements representative of the request (200) for information,
the step of using the elements representative of the request (200) for information, both to select a preferred response (201) to the request (200) and to identify alternative responses (202, 204, 206) transmitted beforehand by operators with respect to prior requests identified by rep selected elements similar to the represented elements of the request for information, and
the step of transmitting to the operator (302) the request for information (200), the selected response (201), and the alternative responses (202, 204, 206).

The present invention relates to a method for assisting a call center operator.

A call center operator must provide responses to various requests. In order to assist in this, it is known to use servers analyzing a request during reception in order to transmit to that operator, in conjunction with the request, possible response categories.

Thus, whenever a request is received by the call center's server—for example, by an e-mail or an SMS, for “Short Messaging Service”, the server analyzes that request in order to identify the keywords that will make it possible to carry out a statistical search among various categories of responses in order to identify the most relevant categories.

By way of example, a request transmitted by e-mail may come in the following form:

### “Could you send me the manual for the XCV drive? Thank you.”

In this situation, a method conforming to the prior art may analyze this request in order to detect the keywords “manual” and “XCV drive.” Based on these keywords, a router tasked with transmitting the request to an operator may identify response categories beforehand, based on statistical criteria, in order to transmit them to that operator with the request.

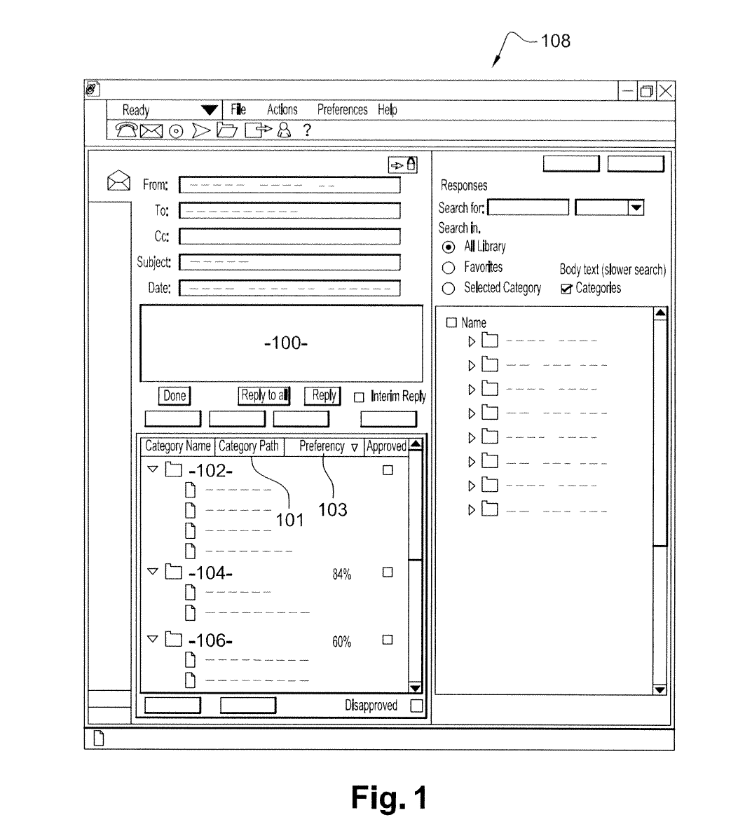

With reference to FIG. 1, an interface used by an operator according to one embodiment is depicted. More specifically, this interface 108 comes in the form of a window displayed on a screen, visible to the operator, and within which the request 100 is presented.

Furthermore, a column 101 exhibits categories 102, 104 and 106, each comprising standard responses related to their categories. Thus, the operator may search, within each category, for a standard response suitable for the request 100.

It is also known, in order to assist this search, to provide that the categories are presented in a statistically-established order of relevance 103.

Such a method is not satisfactory, as the operators are obligated—within each category—to search for the standard response to be transmitted from among a plurality of standard responses provided in each category, with this final search being carried out unassisted.

As a result, this search takes too much time, and therefore too high a cost, to enable a satisfactory processing of requests received by a call center or communication center.

The present invention aims to resolve this problem. It derives from the observation that, whenever an operator has identified the standard response to a request, it is possible to use that identification to associate with that request the standard response actually transmitted by the operator. Thus, if that request is presented again, the standard response that was actually transmitted may be communicated to the operator with the newly presented request.

Thus, the invention relates to a method for assisting an operator from a call center who must respond to a request for information received by that call center, by means of a standard response stored in a base of standard responses, this base of standard responses being automatically used to provide the operator with possible responses to the request for information, characterized in that it comprises the following steps:

the step of identifying elements representative of the request,
the step of using the elements representative of the request for information both to select a preferred response to the request and to identify alternative responses transmitted beforehand by operators respecting prior requests identified by representative elements similar to the elements representative of the request for information, and
the step of transmitting the request for information, the selected response, and the alternative responses to the operator. Owing to the invention, an operator is assisted by means providing him or her, with each request for information, precise and targeted responses that will likely be able to meet the request.

Thus, the operator is not required, as in the prior art, to perform an unassisted search within response categories that may comprise several hundred responses.

In one embodiment, the method comprises the step of indicating, for an alternative response, the number of times that that alternative response has been transmitted by an operator, in response to a prior request similar to the received request.

According to one embodiment, the method comprises the step of limiting the number of times that an alternative response was transmitted by an operator, only to times when the selected response had also been proposed to the operator.

In one embodiment, the method comprises the step of using a router to identify the elements representative of the received request, in order to search in a base of standard responses for the preferred response, and to transmit these representative elements and that standard response to an assistance server and to the operator.

According to one embodiment, the method comprises the step, for the assistance server, of searching for the alternative responses in a base storing the responses transmitted by the operator(s) of the call center depending on corresponding requests.

In one embodiment, the method comprises the step of updating the base, storing the alternative responses and the value of the number indicating how many times they have been transmitted in response to a request, whenever sending a standard response to a request.

The invention also pertains to a server for assisting an operator of a call center who must respond to a request for information received by that call center, by means of a standard response stored in a base of standard responses, this base of standard responses being automatically used to provide the operator with possible responses to the request for information, characterized in that it comprises:
means for receiving elements representative of the request for information and a preferred response to that request for information,
means for identifying alternative responses transmitted beforehand by operators with respect to prior requests identified by representative elements similar to the elements representative of the request for information, and
means for transmitting the alternative responses to the operator according to a method as claimed in one of the preceding claims. Finally, the invention relates to a base for assisting an operator of a call center who must respond to a request for information received by that call center, by means of a standard response stored in a base of standard responses, this base of standard responses being automatically used to provide the operator with possible responses to the request for information, characterized in that it comprises:
means for receiving elements representative of the request for information and a preferred response to that request for information,
means for identifying alternative responses transmitted beforehand by operators with respect to prior requests identified by representative elements similar to the elements representative of the request for information, and
means for transmitting the server the alternative responses according to a method as claimed in one of the preceding claims.

The invention shall be better understood upon reading the description below, which is given only as a nonlimiting example, with reference to the attached drawings in which:

FIG. 1, already described, is an illustration of the assistance carried out by a call center server according to the prior art,

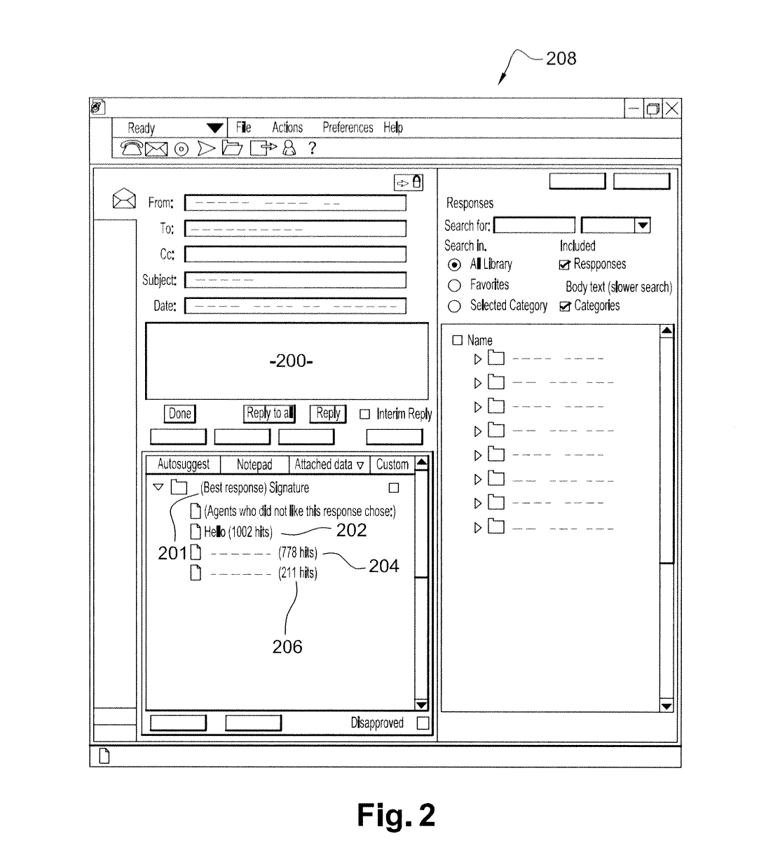

FIG. 2 is an illustration of the assistance carried out by a server as claimed in the invention, and

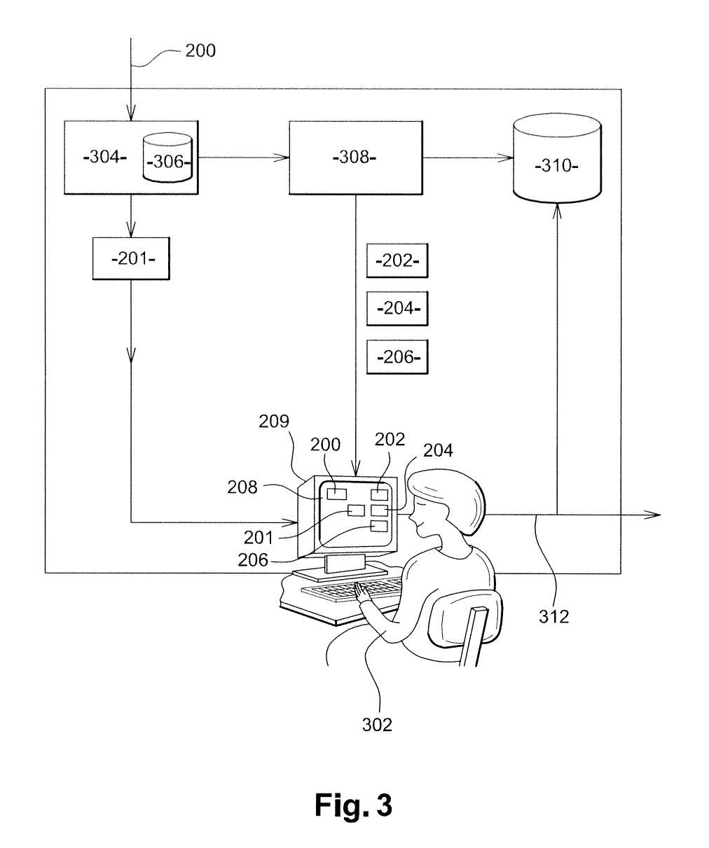

FIG. 3 is a diagram representative of the implementation of a method as claimed in the invention.

With reference to FIG. 2, the interface used by an operator according to one mode of operation as claimed in the invention is depicted. More specifically, this interface 208 appears as a window displayed on a screen, consulted by an operator, and within which a request 200 is presented.

Furthermore, a column presents, first, a response 201 automatically selected based on elements representative of the request 200—keywords, in this embodiment—and statistical operations and, second, alternative responses 202, 204, and 206 which have been adopted by operators respecting similar prior requests, i.e. those presenting representative elements that are analogous or identical to those of the request 200.

Additionally, to assist the operator in a potential search from among the alternative responses 202, 204, and 206, it is indicated by each alternative response the number of times, or “hits,” that this alternative response was adopted—between parentheses in FIG. 2.

With reference to FIG. 3, steps are described below that are implemented in a method as claimed in the invention, with this description being made using references to FIG. 2 for those elements already described within that FIG. 2.

Firstly, the request for information 200 is transmitted to an operator 302 by means, for example, of an e-mail, a telephone call, or an SMS (for “Short Message Standard”).

During a first step, a router 304 identifies the elements representative of the request 200, for example keywords, which it uses to select, within a base 306 of standard responses, the standard response 201 having the highest match with that request according to search criteria such as statistical, lexical, or semantic criteria.

In parallel, these keywords and the selected response are transmitted to an assistance server 308 associated with a database 310 storing the responses transmitted by the operator(s) of the call center as a function of the corresponding requests.

By consulting this database 310, the server 308 can identify the alternative responses, transmitted by the operator(s) of the call center, in response to a similar prior request which differs from the selected response.

Thus, the operator 302 receives the request 200 as well as response elements formed by, firstly, the response 201 automatically selected based on the request's keywords, and secondly, alternative responses 202, 204, and 206 which had been adopted by operators with respect to a single request.

As already indicated, the alternative responses may comprise an indication of the number of times that each one of them had been transmitted in response to the request.

In one variant, the indication of the number of times that an alternative response 202, 204, or 206 was transmitted in response to a request may correspond, more specifically, to the number of times that that alternative response had been preferred—and therefore transmitted—to that same selected response 201.

From that time forward, the operator 302 can rapidly and easily consult, on his or her screen 208 of the interface 209 presenting the request 200, the selected response 201 and the alternative responses 202, 204, and 206, in order to identify the standard response that meets the request 201.

Whenever the operator 302 has identified the standard response that must be transmitted in response to the request 200, a transmission 312 of that standard identified response is conveyed to the sender of the request 200. However, at the same time as that transmission, the base 310 is updated by receiving a copy of the identified response—which thereby increases by one unit for each time that the identified response was adopted for the request 200.

The present invention is subject to many variants. In particular, the bases 306 and 310 may be formed by a single base accessible to the analyzer 304 and to the server 308.

Furthermore, different languages and protocols may be implemented in order to enable a satisfactory communication between the various elements of the system, and particularly, between the router 304, the server 308, and the interface 209. Furthermore, various programming languages, such as SQL for “Structured Query Language,” may be implemented in order to manage this database.

Additionally, the router 304 may have access to the base 310 so that, for example, the method determining the selected response takes into account the number of times that that response had been transmitted for a request.

Finally, it should be noted that, in the embodiment above, the elements representative of a request are keywords, but other parameters, such as geographical origin, the address of the request's sender or the date of the request, may be taken into account in order to define a request.

1. A method for assisting an operator from a call center who must respond to a request for information (200), received by that call center, by means of a standard response stored in a base (306, 310) of standard responses, this base (306, 310) of standard responses being automatically used in order to provide the operator (302) with possible responses to the request for information (200), wherein it comprises the following steps:
the step of identifying elements representative of the request (200) for information,
the step of using the elements representative of the request (200), both to select a preferred response (201) to the request (200) and to identify alternative responses (202, 204, 206) transmitted beforehand by operators with respect to prior requests identified by representative elements similar to the represented elements of the request for information, and
the step of transmitting to the operator (302) the request for information (200), the selected response (201), and the alternative responses (202, 204, 206).

2. A method according to claim 1, wherein it comprises the step of indicating, for an alternative response 202, 204, 206), the number of times that that alternative response (202, 204, 206) was transmitted by an operator (302) in response to a prior request (200) similar to the received request.

3. A method according to claim 2, wherein it comprises the step of limiting the number of times when an alternative response (202, 204, 206) was transmitted by an operator (302) only to the times when the selected response (201) was also proposed to that operator (302).

4. A method according to claim 1, wherein it comprises the step of using a router (304) for identifying the elements representative of the request (200), for searching within a base (306) of standard responses for the preferred response (201), and for transmitting these representative elements and that standard response (201) to an assistance server (308) and to the operator (302).

5. A method according to claim 4, wherein it comprises the step, for the assistant server (308), of searching for alternative responses (202, 204, 206) within a base (310) storing the responses transmitted by the operator(s) of the call center as a function of the corresponding requests (200) and the number of transmissions of that standard response that have been made.

6. A method according to claim 5, wherein it comprises the step of updating the base (310) storing the alternative responses (202, 204, 206) and the value of the number indicating the times they were transmitted in response to a request.

7. A server (308) for assisting an operator (302) from a call center who must respond to a request for information (200), received by that call center, by means of a standard response stored in a base (306, 310) of standard responses, this base (306, 310) of standard responses being automatically used in order to provide the operator (302) with possible responses (201, 202, 204, 206) to the request for information (200), wherein it comprises:
means for receiving elements representative of the request for information and a preferred response (201) to that request for information,
means for identifying alternative responses (202, 204, 206) transmitted beforehand by operators with respect to prior requests identified by representative elements similar to the elements representative of the request for information, and
means for transmitting the alternative responses to the operator (302) according to a method (202, 204, 206) as claimed in claim 1.

8. A base (310) for assisting an operator (302) of a call center who must respond to a request for information (200) received by that call center, by means of a standard response stored in a base (306, 310) of standard responses, this base (306, 310) of standard responses being automatically used to provide the operator with possible responses (201, 202, 204, 206) to the request (200) for information, wherein it comprises:
means for receiving elements representative of the request for information and a preferred response to that request for information,
means for identifying alternative responses transmitted beforehand by operators with respect to prior requests identified by representative elements similar to the elements representative of the request for information, and
means for transmitting the alternative responses to a server according to a method as claimed in claim 1.
